(19) United States
(12) Patent Application Publication
(10) Pub. No.: US 2006/0196049 A1
(43) Pub. Date: Sep. 7, 2006

(54) Method for assembling a non-linear composite tube

(76) Inventor: David Opperman, Plainfield, CT (US)

Correspondence Address: ALIX YALE & RISTAS LLP, 750 MAIN STREET, SUITE 1400, HARTFORD, CT, 06103, US

(21) Appl. No.: 11/359,630

(22) Filed: Feb. 22, 2006

Related U.S. Application Data
(63) Continuation-in-part of application No. 11/074,146, filed on Mar. 7, 2005.

(51) Int. Cl. B21D 51/16; F16L 37/00

(52) U.S. Cl. 29/890.08; 285/33

(57) ABSTRACT

The present invention discloses a method and hardware apparatus that facilitate temporary mechanical alignment and assembly of discrete straight tube portions and tube bend portions. The temporary mechanical assembly permits a fabricator to “mock-up” the desired non-linear composite tube before any of the tube portions are permanently welded to the other.

### CROSS REFERENCE TO RELATED APPLICATIONS

This application is a continuation-in-part of U.S. application Ser. No. 11/074,146, filed Mar. 7, 2005.

### BACKGROUND OF THE INVENTION

1. Field of the Invention

The present invention relates generally to tubular assemblies and more particularly to a method for constructing one of a kind non-linear composite tubular assemblies.

2. Description of the Related Art

Internal combustion engines produce hot exhaust gases which must be collected and directed away from the internal combustion engine. Such collection is typically carried out by means of an exhaust system. Exhaust systems typically begin with an exhaust manifold secured over the exhaust ports on the internal combustion engine. The exhaust manifold collects and combines exhaust flow from the several exhaust ports into a single exhaust outlet. An exhaust pipe typically connects to the exhaust manifold and directs exhaust gases to a catalytic converter, muffler and ultimately to a tailpipe. The exhaust system components are typically tubular assemblies that are connected in a sealed manner to contain the hot and noxious exhaust gasses. The tubular portions of an exhaust system that extend between system components such as the manifold and catalytic converter are typically non-linear because of the spatial constraints in the engine compartment and beneath the motor vehicle. Standard exhaust pipes and tailpipes are typically constructed from steel tubing.

Internal combustion engines are installed in antique and classic cars, custom cars or trucks, high performance cars and boats. These installations frequently require custom exhaust systems whose appearance, exhaust flow and exhaust tone are important to the purchaser. Typical after market exhaust systems cannot meet these requirements, in part, because they are produced from steel tubing formed on inexpensive compression-type tube benders. Compression-type tube benders significantly reduce the cross-sectional area of the tube in the area of a bend, resulting in an undesirable restriction of the exhaust flow through the tube. After market exhaust systems are also generally unattractive in appearance and prone to rust that necessitates frequent repair or replacement.

It is known to produce custom exhaust assemblies by welding together a sequence of straight and bent tubular portions. More expensive materials such as stainless steel alloy tubes result in substantially permanent, rust free exhaust systems. The tube bends used in these custom installations may be produced on more expensive mandrel-type tube benders that maintain the cross-sectional area of the tube. Because of their substantially constant diameter and wrinkle free appearance, tube bends from a mandrel-type bender produce an attractive finished tubular assembly. Custom fabricators typically purchase U-bends (180° bends) of the desired tube material and diameter, then cut the U-bends to a desired bend angle and weld the tube bend portion in sequence with straight tube portions to produce a custom exhaust pipe having a desired non-linear configuration.

Assembly of a tube bend portion to a straight tube portion is typically accomplished by manually positioning the tube bend portion relative to the straight tube portion and tack welding it in place. If the tack welded assembly does not provide the required exhaust pipe configuration (does not fit or look right), the assembly must either be separated or discarded. When a composite tubular assembly has been completely tack welded, each joint is finish welded, ground and sanded to produce an apparently continuous, seamless non-linear tube. Manual positioning and tack welding of tubular components using trial and error is time intensive, labor intensive, and can result in large amounts of scrap material. This method also requires a high level of skill on the part of the fabricator to produce custom tubular assemblies of commercially acceptable fit and finish.

There is a need in the art for an assembly method and apparatus that permits temporary mechanical assembly of straight tube portions and tube bend portions before the tube portions are welded to form a composite non-linear tube.

An object of the present invention is to provide a new and improved method and apparatus that reduce the time and expense of producing customized non-linear composite tubular assemblies from discrete straight and bent tube portions.

### SUMMARY OF THE INVENTION

Briefly stated, the present invention comprises a method, system and hardware apparatus that facilitate temporary mechanical alignment and assembly of discrete straight tube portions and tube bend portions. The temporary mechanical assembly permits a fabricator to “mock-up” the desired non-linear composite tube before any of the tube portions are permanently welded to the other.

The system provides a fabricator with a stock of tube bend portions defining a range of bend angles from approximately 5° to approximately 140° by 2° increments. Such a stock of tube bend portions is provided for each tube diameter and material. The tube bend portions are produced on a mandrel-type bender, so they are wrinkle free and of substantially constant diameter. The mandrel bending process can slightly deform the diameter and circularity of the bent tube, so the method includes a step of re-forming (swaging) the ends of each tube bend portion to a circular configuration of the correct diameter to ensure accurate alignment of the end faces of adjacent tube portions. The end faces of the tube bend portions and straight tube portions are substantially perpendicular to the axis of the tubes.

In one embodiment, an array of threaded studs is welded adjacent each end of each tube bend portion. The threaded studs are configured to project generally parallel to an axis of the tube and extend axially beyond the ends of the tube bend portion. Straight tube portions of desired length are cut from the appropriate diameter straight tube. Each straight tube portion is provided with a radially projecting anchor defining apertures configured to receive the threaded studs. The radially projecting anchor can be provided in several different hardware configurations as described in greater detail below.

A fabricator selects what is believed to be the proper tube bend portion and axially inserts the threaded studs of that tube bend portion through the apertures of the anchor mounted to an adjacent straight tube portion. Nuts are engaged over the threaded studs, the radial alignment and rotational position of the two tubes is set and the nuts are tightened to generate a compressive force that will maintain alignment of the tube portions. This process is repeated until the fabricator has assembled a mechanically coupled non-linear composite tube of the desired configuration. The mechanically assembled tube can then be checked for fit and tack welded. The anchors and threaded studs are configured such that when the tube is mechanically coupled, the butt joint formed by the end faces of adjacent tube portions is accessible at several angularly spaced points around the joint. When the composite tube is tack welded, the threaded studs and anchors are removed, the joint weld is completed, and any marks are ground off. The completed weld is sanded and buffed to a smooth finish.

The composite non-linear tubular assembly can be disassembled at any time during the process of mechanical assembly to correct defects in configuration. The tube bend portions can be re-used in other assemblies.

### BRIEF DESCRIPTION OF THE DRAWINGS

FIG. 1 is an enlarged perspective view of a rectangular anchor compatible with the present invention;

FIG. 2 is a perspective view illustrating the attachment of the rectangular anchor of FIG. 1 to a straight tube portion by means of a capacitor discharge stud welder;

FIG. 3 illustrates the straight tube portion of FIG. 2 being joined to a selected tube bend portion equipped with axially extending threaded studs according to aspects of the present invention;

FIG. 4 illustrates the straight tube portion and tube bend portion of FIG. 2 assembled to a second straight tube portion according to aspects of the present invention;

FIGS. 5-7 are preassembly, assembled open and closed views of a split clamp collar according to aspects of the present invention;

FIGS. 8-13 illustrate a composite tube assembly method according to aspects of the present invention carried out using the split clamp collar of FIGS. 5-7;

FIGS. 14-18 illustrate a tube assembly method employing threaded stud-mounted angle brackets as anchors according to aspects of the present invention;

FIGS. 19 and 20 illustrate a second split clamp collar compatible with aspects of the present invention;

FIG. 21 illustrates the clamp collar of FIGS. 19 and 20 tack welded to a selected straight tube portion and employed as an anchor to mechanically couple a tube bend portion according to aspects of the present invention;

FIG. 22 illustrates a third embodiment of the split clamp collar compatible with aspects of the present invention;

FIG. 23a is a perspective view of the flange support according to aspects of the present invention;

FIG. 23b is a side elevational view of FIG. 23a tack welded to a selected straight tube portion according to aspects of the present invention;

FIG. 23c is a partial sectional view of a selected straight tube portion equipped with axially extending threaded studs according to aspects of the present invention;

FIG. 24 illustrates the collar of FIG. 22 being closed over the straight tube portion and flange of FIG. 23b to provide an anchor according to aspects of the present invention;

FIG. 25a is a side view partially in section of the anchor/straight tube assembly of FIG. 24; and

FIG. 25b is an enlarged sectional view of a portion of FIG. 25a.

### DETAILED DESCRIPTION OF THE PREFERRED EMBODIMENTS

The disclosed method may be carried out using several different hardware configurations. The various hardware configurations provide a mechanical coupling between adjacent portions of a composite tubular assembly. The mechanical coupling in its most basic form includes a plurality of axially extending threaded studs joined to one end of a tube and a radially projecting anchor affixed to an end of an adjacent tube. The threaded studs and anchor are configured and arranged such that the free ends of each threaded stud passes through an aperture defined by the anchor. A threaded nut is engaged with the studs and tightened to bring the end faces of the tubes into compressive engagement. Before the nuts are fully tightened, the lateral and rotational alignment of the tube ends can be adjusted. All of the hardware configurations facilitate alignment of the tubes by permitting lateral and rotational movement of one tube relative to the other. The studs and anchors are also configured so that the butt joint formed between the end faces of adjacent tubes is accessible at several angularly spaced locations around the circumference of the joint to permit tack welding.

An aspect of the present invention relates to providing custom exhaust fabricators with a stock of tube bend portions defining bend angles from approximately 5° to approximately 140° in approximately 2° increments. According to one exemplary embodiment of the present invention, an array of threaded studs is welded adjacent each end of each tube bend portion. Each array of threaded studs comprises three studs welded to the outside surface of the tube bend portion in an equiangular arrangement. The studs may be welded to the tube bend portion by capacitor discharge welding or conventional welding. A further aspect of the present invention relates to an angular offset between the stud array at one end of a tube bend portion relative to the stud array at the opposite end of the tube bend portion. According to the present invention the arrays are offset by approximately 60°. The angular offset permits maximum flexibility when assembling a tube bend portion to a selected straight tube portion. If the tube alignment is incorrect using one array of studs, then the tube bend portion may be reversed to employ the other array of studs at a different rotational position.

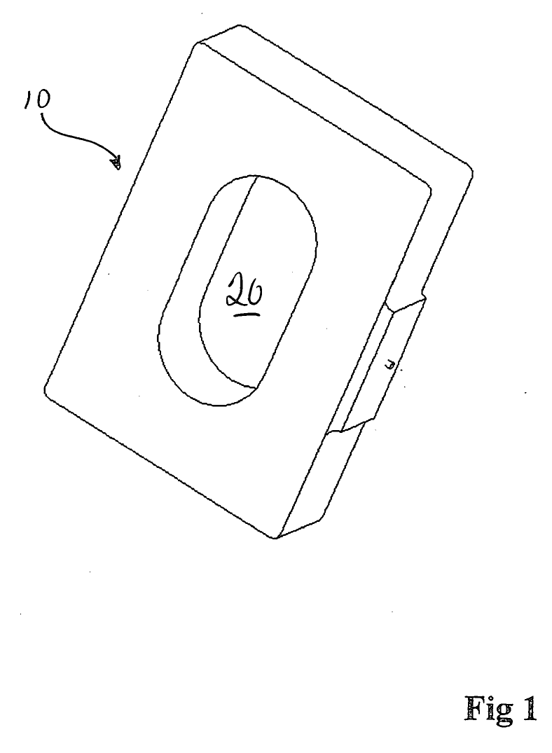

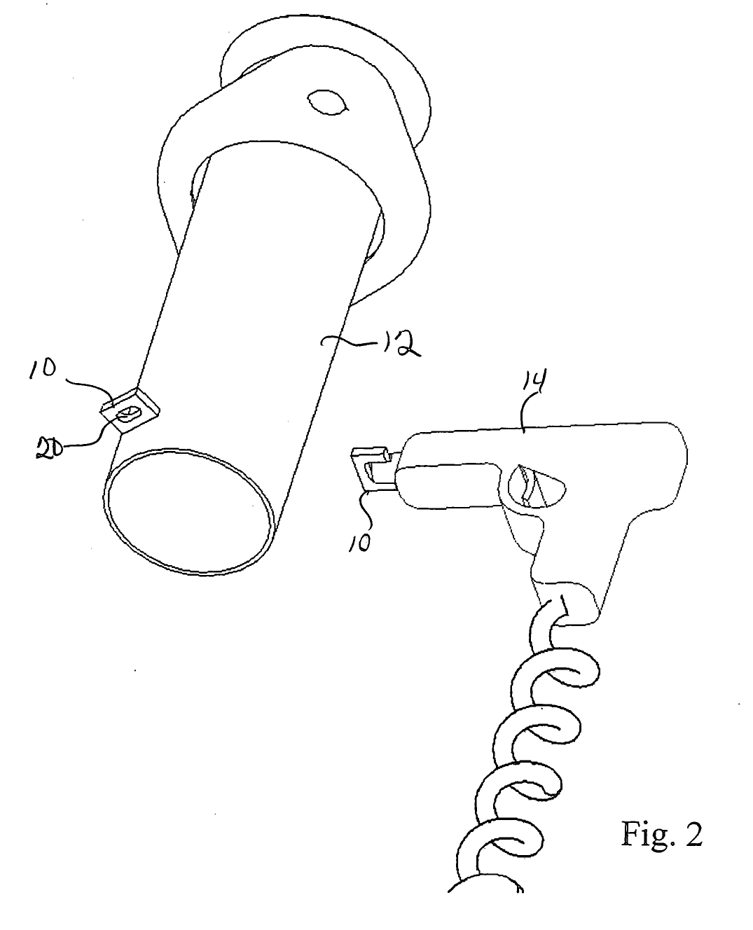

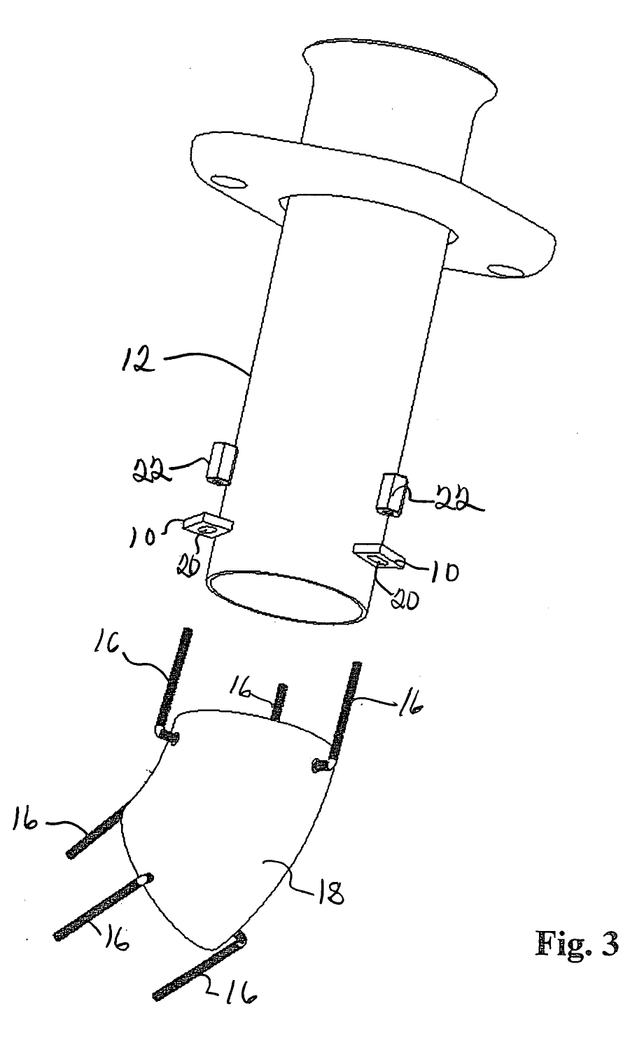

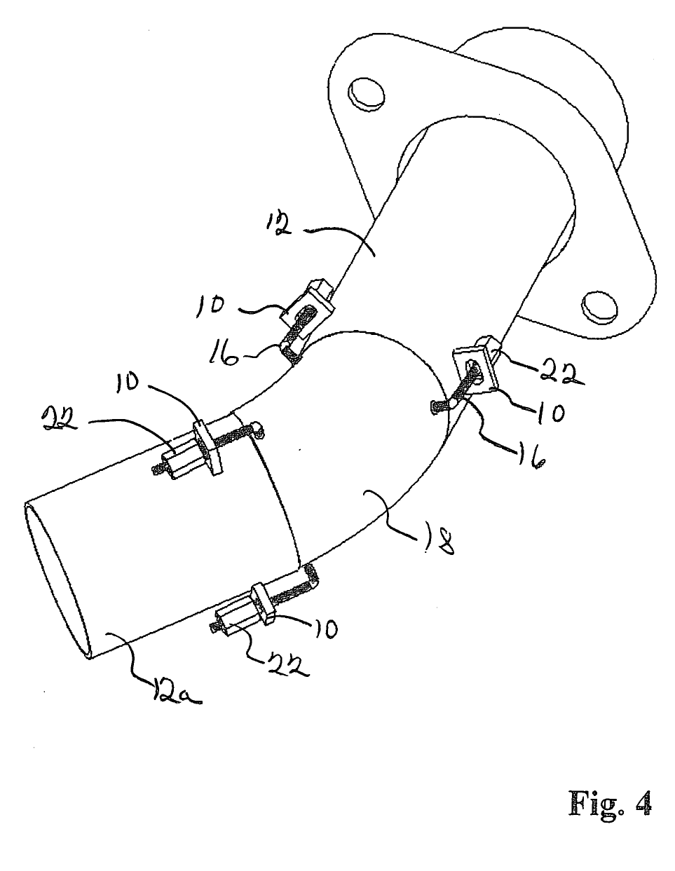

Specific hardware configurations will now be described with reference to the Figures. FIG. 1 illustrates an exemplary rectangular anchor 10 configured for welding to the outside surface of a selected straight tube portion 12 as illustrated in FIG. 2. According to aspects of the present invention, the rectangular anchors 10 may be welded to the straight tube portion 12 by capacitor discharge welding, although other welding methods are compatible with the present invention. A representative capacitor discharge welding tool 14 is shown in FIG. 2. The anchors 10 are positioned to align with the three threaded studs 16 extending from the selected tube bend portion 18 as seen in FIG. 3. The rectangular anchors 10 define an elongated (oval) aperture 20 oriented to permit relative rotational movement between the straight tube portion 12 and the tube bend portion 18 after assembly as shown in FIG. 4. When the fabricator is satisfied with the lateral and rotational alignment of the straight tube portion 12 and tube bend portion 18, threaded nuts 22 are tightened over the threaded studs 16 to secure the tubes in place.

A further straight tube portion 12a is cut and provided with rectangular anchors 10. The second straight tube portion 12a is then secured to the free end of the tube bend portion 18 as shown in FIG. 4. This process is repeated until a composite non-linear tube of the desired configuration is constructed. The composite tube is maintained in its selected configuration by the threaded studs 16, rectangular anchors 10 and nuts 22. This method permits a fabricator to “mock-up” a complex composite tubular structure and hold it in the desired configuration without resorting to welding adjacent tubes to each other. If the fit is determined to be incorrect, the tube portions 12, 18, 12a can be mechanically disassembled and adjusted or particular components replaced without creating scrap or requiring excessive cutting and grinding of welded parts.

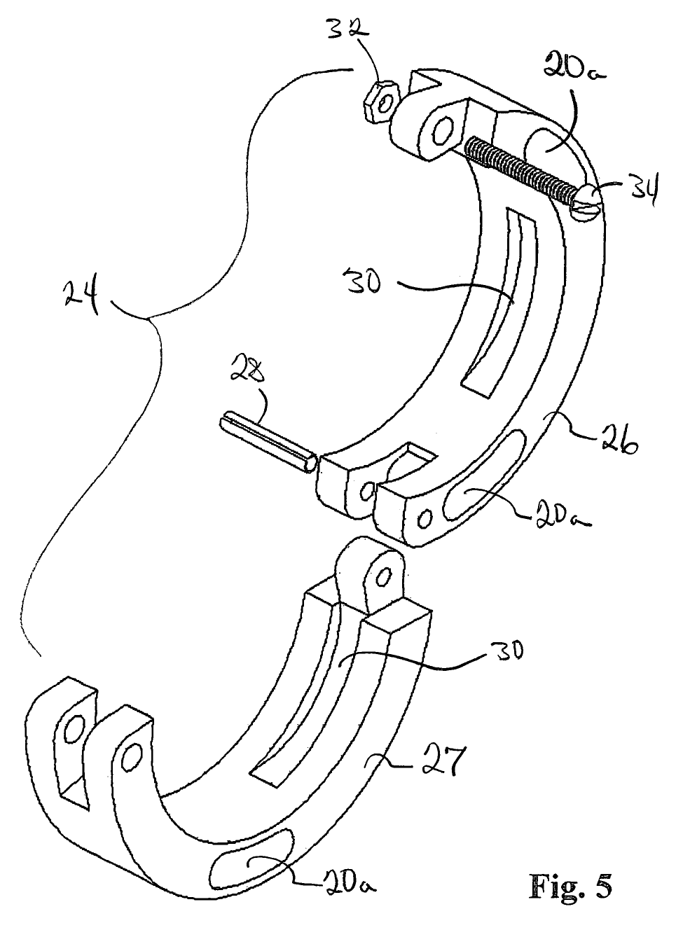

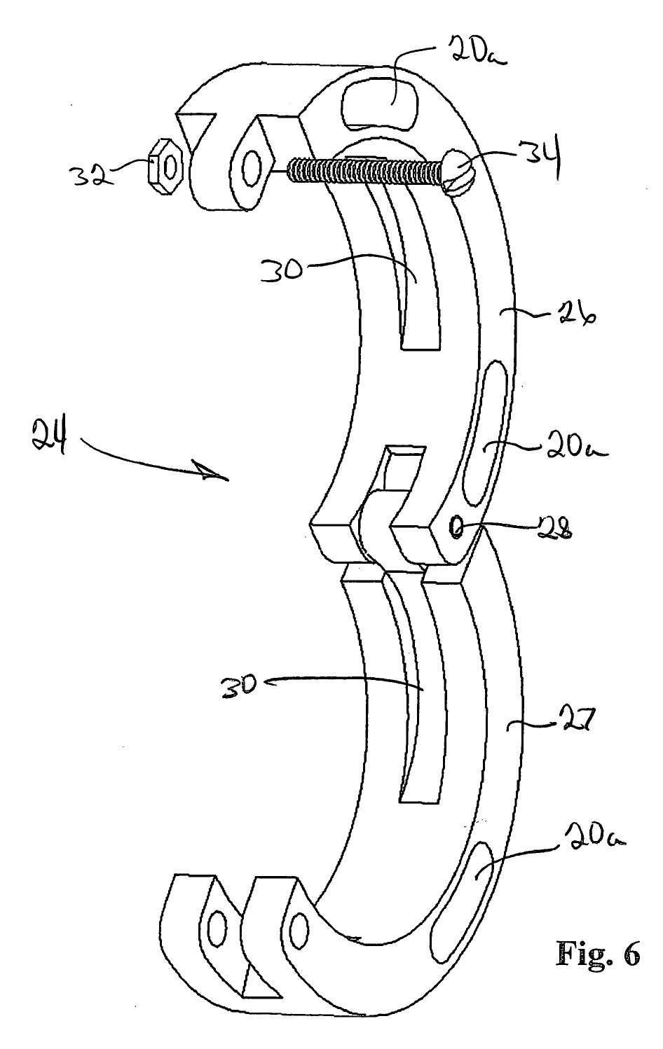

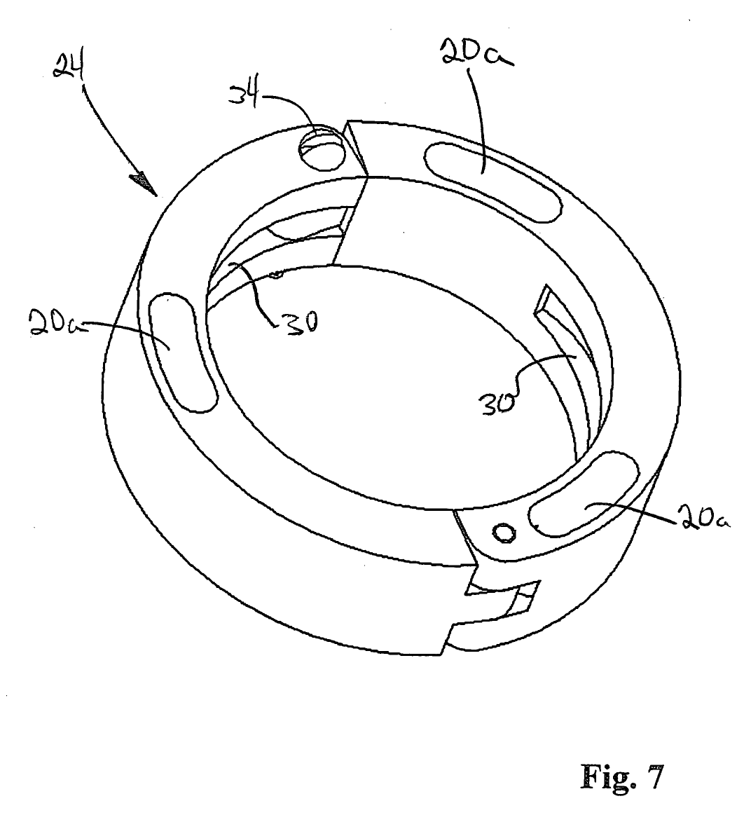

FIGS. 5-7 illustrate a split clamp collar 24 compatible with a further hardware embodiment of the present invention. The split clamp collar is formed of two components 26, 27 held together by a hinge pin 28. The clamp collar 24 is configured to open for placement around one end of a tube portion. The clamp collar defines a plurality of interior grooves 30. The interior grooves 30 are shown as interrupted, but may be continuous about the inside circumference of the clamp collar 24. The clamp collar 24 defines a plurality of elongated arcuate axial apertures 20a arranged to receive the threaded studs 16 of a selected tube bend portion 18. FIG. 7 illustrates the clamp collar 24 in its closed position, secured by a nut and bolt 32, 34.

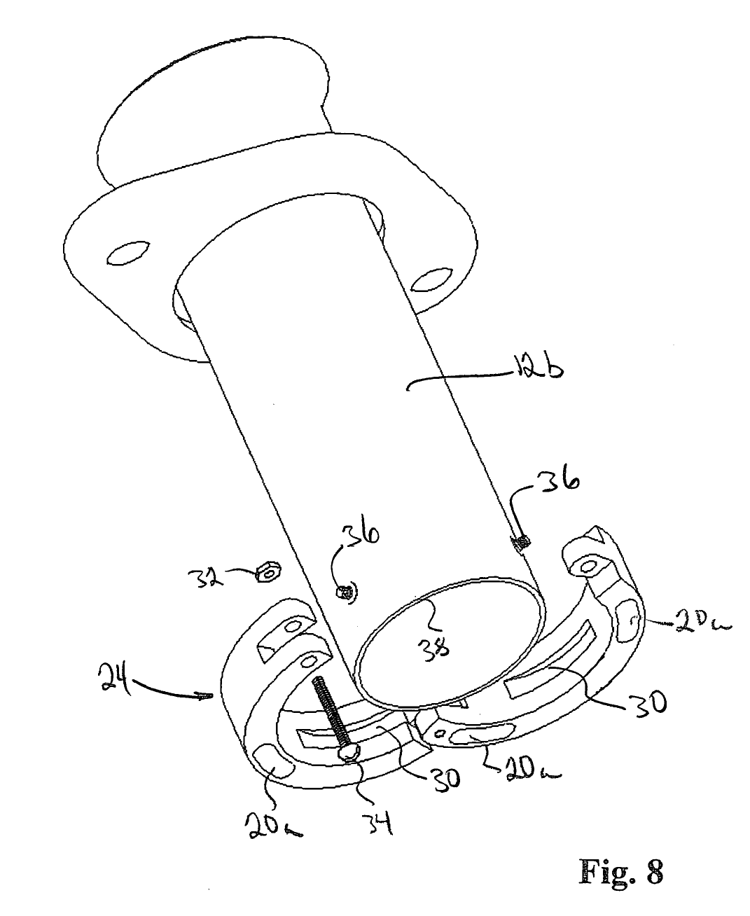

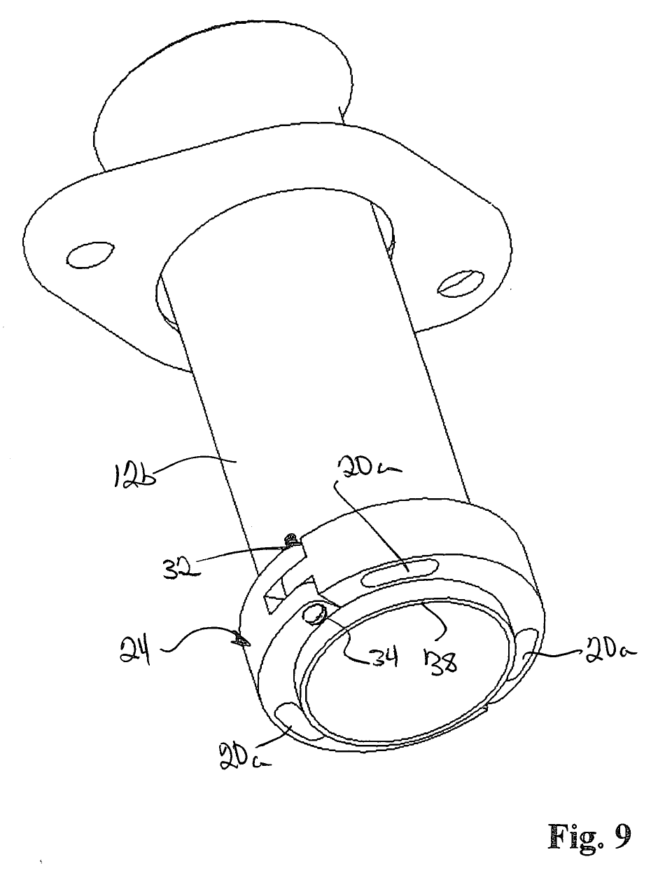

FIG. 8 illustrates an array of short weld studs 36 adjacent the end face 38 of a straight tube portion 12b. The studs 36 are placed at approximately the same axial distance from the end face 38 and together provide a radially projecting shoulder. The clamp collar 24 is closed over the weld studs 36 so that the studs are received in the interior grooves 30. The interior grooves 30 are configured to permit relative rotational movement between the clamp collar 24 and the straight tube portion 12b, with the weld studs 36 moving along the grooves 30 defined by the collar 24. At the same time, the weld studs 36 are trapped in the groove 30 and do not permit axial movement of the clamp collar 24 along the straight tube portion 12b. When the clamp collar 24 is closed over the weld studs 36 and secured by a screw and nut 32, 34 as shown in FIG. 9, the clamp collar 24 provides a secure anchor radially extending from the straight tube portion 12b. Specifically, the clamp collar 24 abuts the radially projecting shoulder provided by the several studs 36 to prevent axial movement of the collar towards the end face 38.

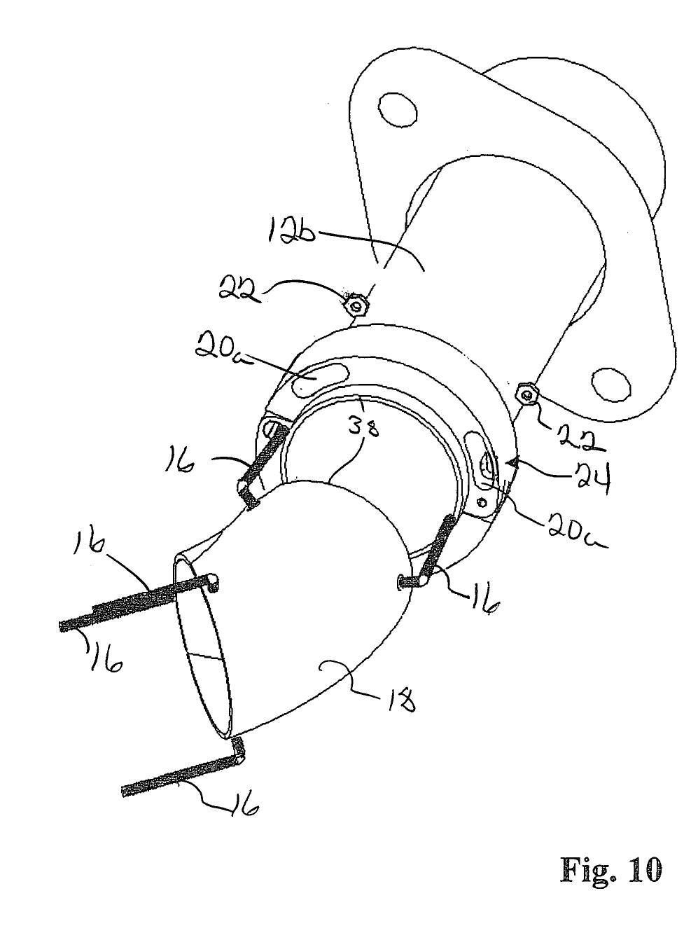

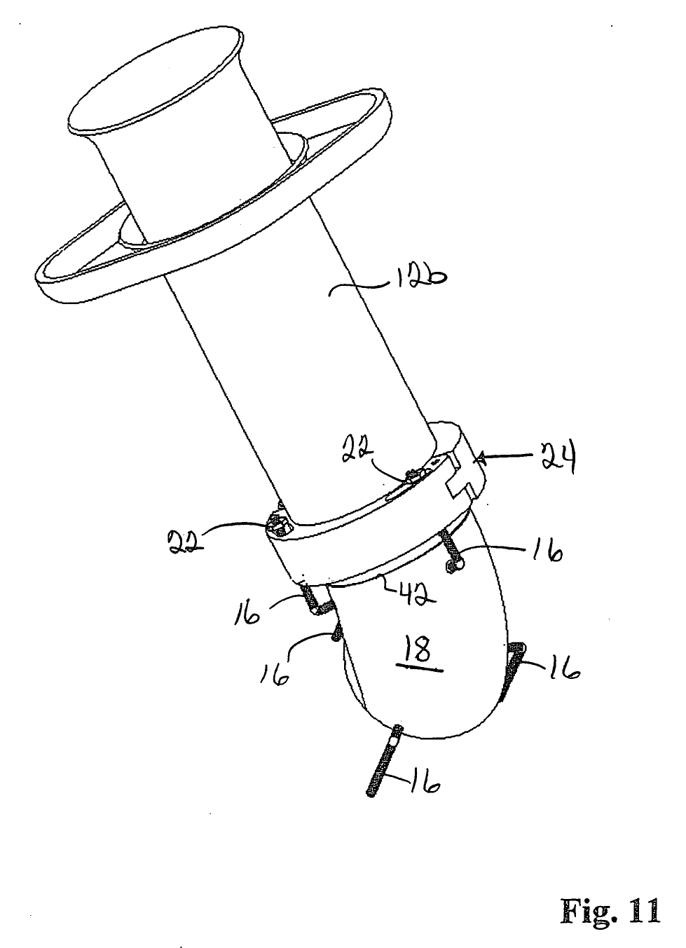

A selected tube bend portion 18 can then be assembled to the straight tube portion 12b as shown in FIG. 10. The rotational movement of the clamp collar 24 relative to the straight tube portion 12b and the elongated arcuate apertures 20a of the collar permit significant rotational and limited lateral movement of the tube bend portion 18 relative to the tube straight portion 12b. When the fabricator has aligned the tube bend portion 18 and the tube straight portion 12b in the desired configuration, the nuts 22 are tightened to maintain the selected position as shown in FIG. 11.

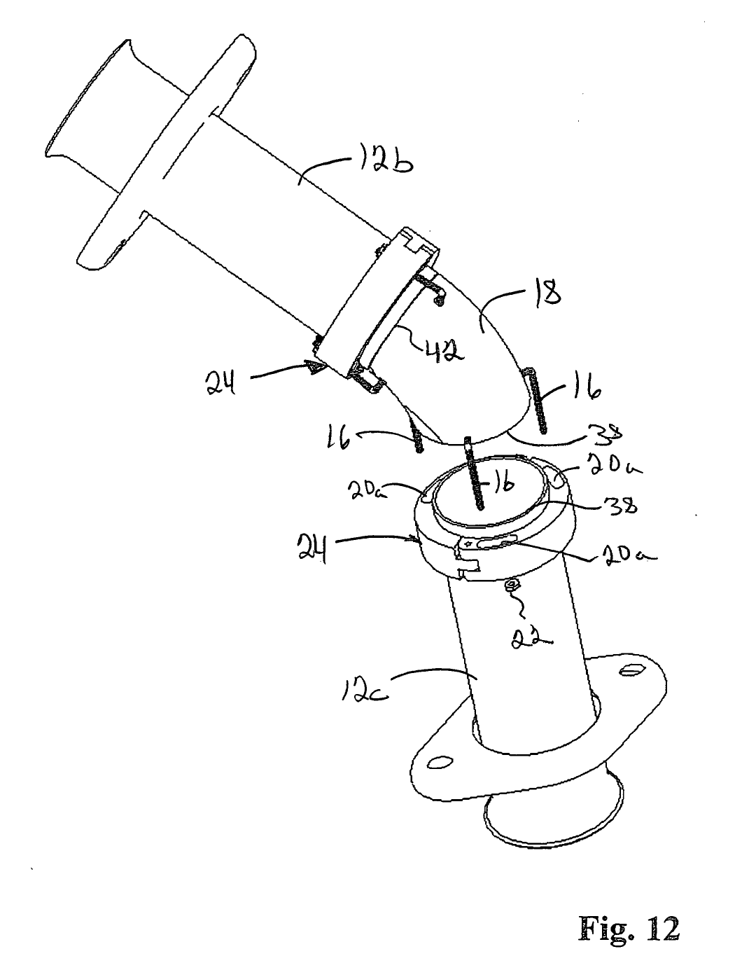

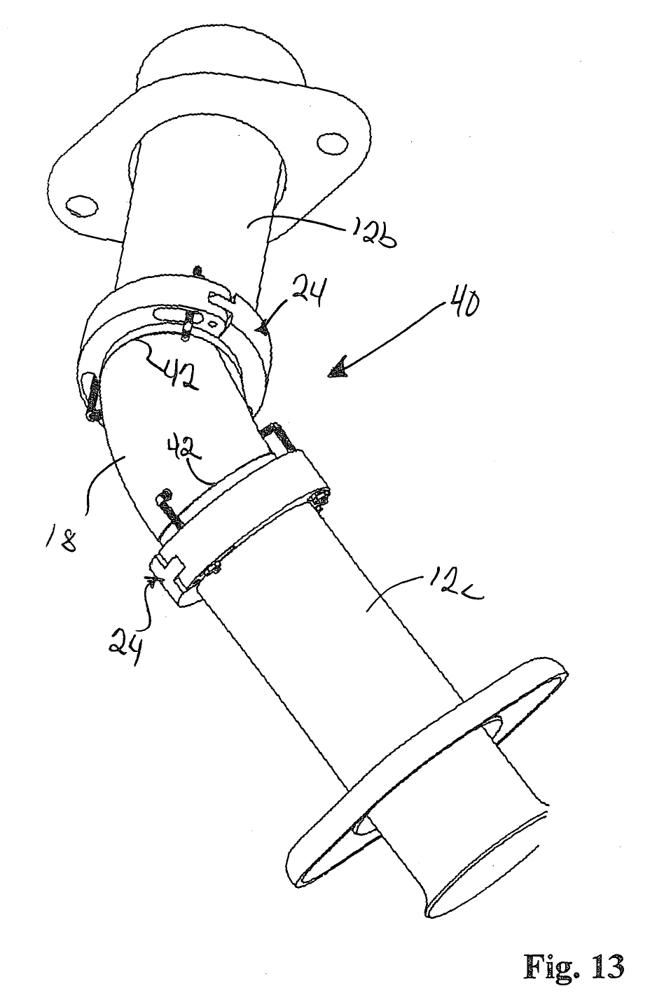

This process is repeated with a second straight tube portion 12c as shown in FIGS. 12 and 13. A mechanically coupled non-linear tubular assembly 40 shown in FIG. 13 can be tack welded at several points around the circumference of the butt joints 42 formed by the end faces 38 of adjacent tubes. Once the tubular assembly 40 is secured by tack welding, the nuts 22 and clamps 24 are removed, the threaded studs 16 are ground off, the weld is completed around the circumference of the joint 42, and the weld is ground and sanded to a finished appearance. The split clamp collars 24 facilitate both installation and removal of the clamp collars after the tube portions are welded to form the composite tubular assembly.

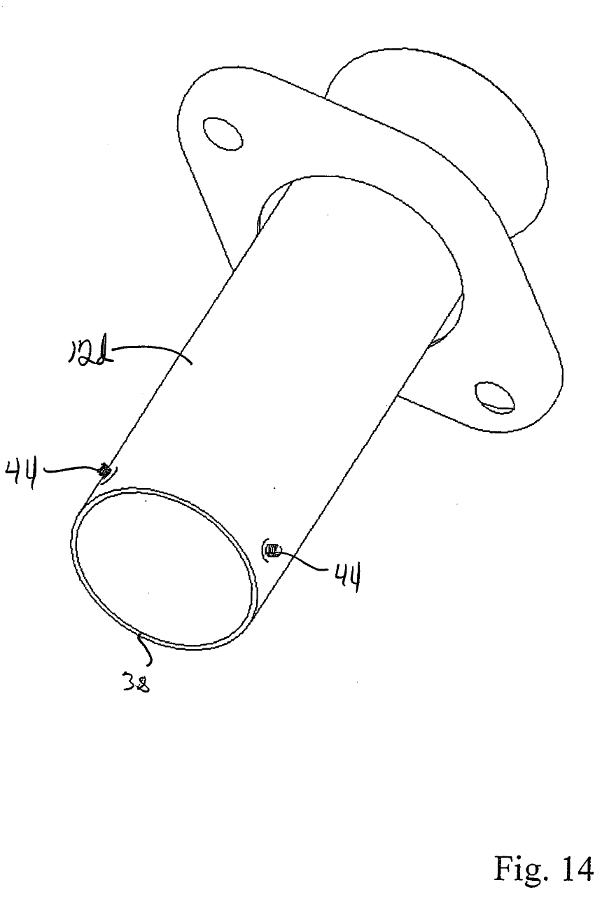

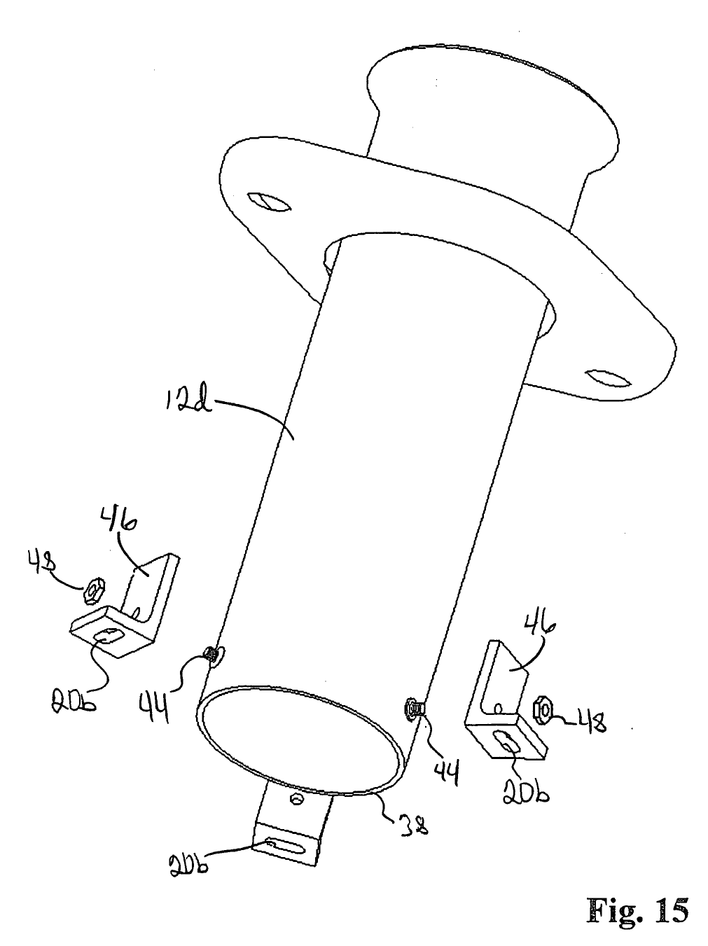

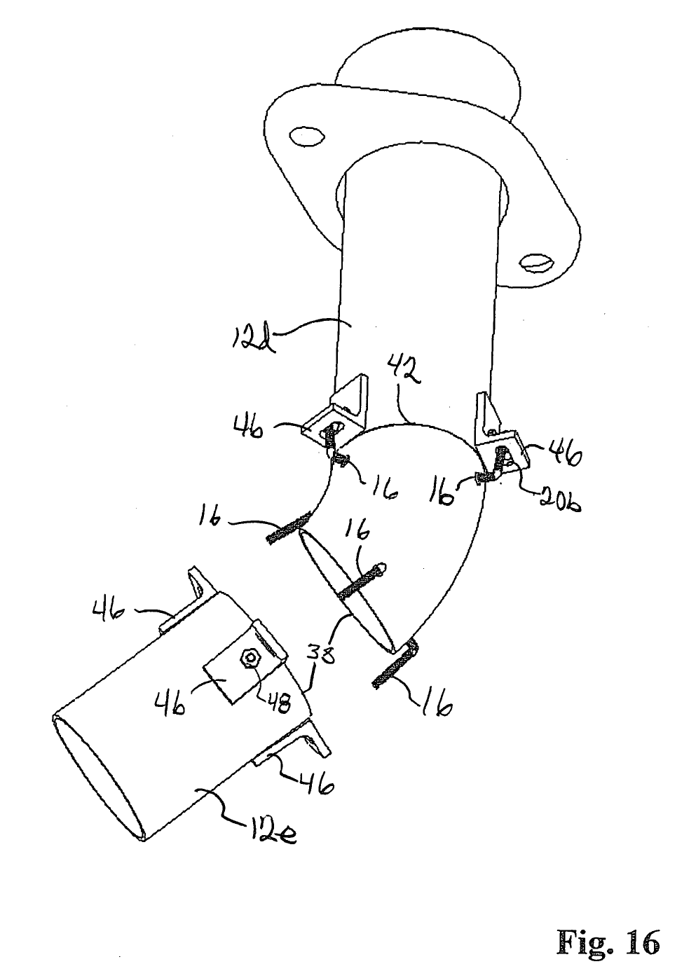

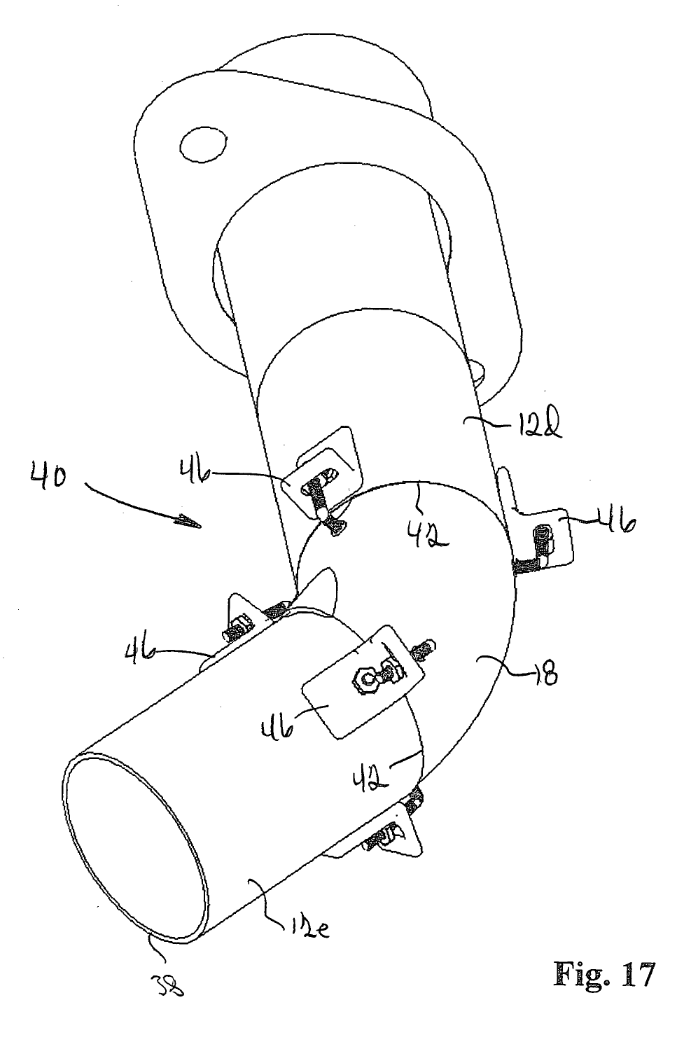

FIGS. 14 and 15 illustrate a further variation of hardware employed to provide a radially extending anchor compatible with the present invention. Short, threaded studs 44 are fixed in an array adjacent an end face 38 of a selected straight tube portion 12d. Angle brackets 46 are engaged over the threaded studs 44 and secured with nuts 48. This arrangement provides radially extending anchors with axially oriented apertures 20b in an array compatible with the axially extending threaded studs 16 affixed to the tube bend portions 18. Assembly of tube bend portions 18 and straight tube portions 12d, 12e using this hardware configuration is illustrated in FIGS. 16 and 17. The mechanically coupled tubular assembly 40 is tack welded prior to removal of the hardware, finish welding and grinding.

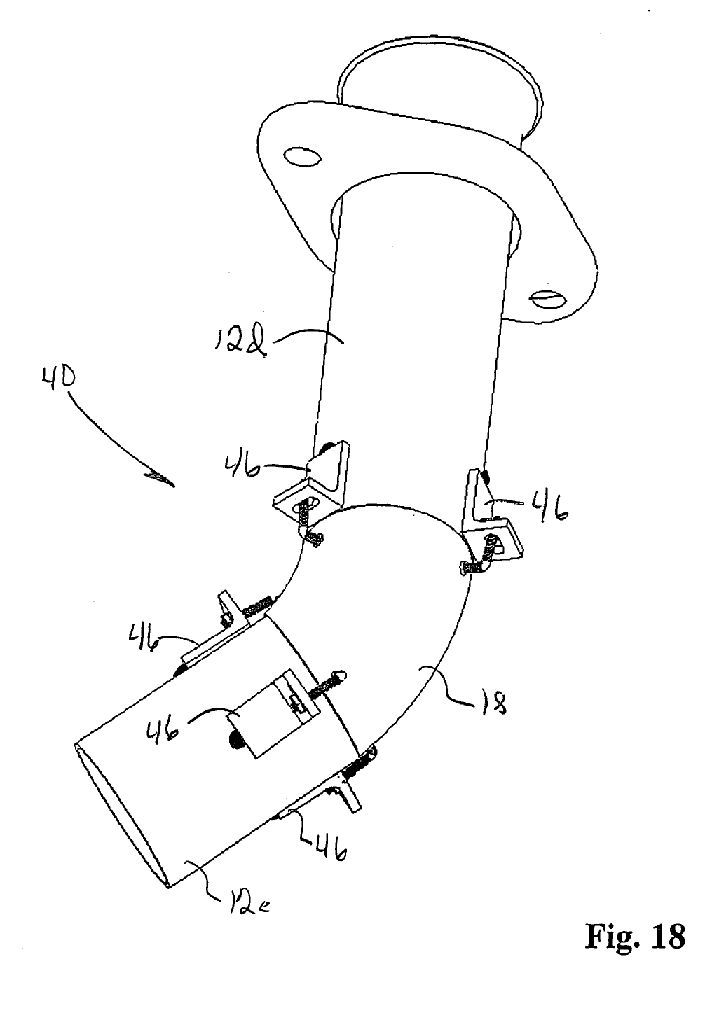

FIG. 18 illustrates an alternative hardware arrangement in which the angle brackets 46 are tack welded in place rather than employing threaded studs 44 and nuts 48. The angle brackets of FIGS. 15-18 provide a radially projecting anchor for engagement by the threaded studs 44.

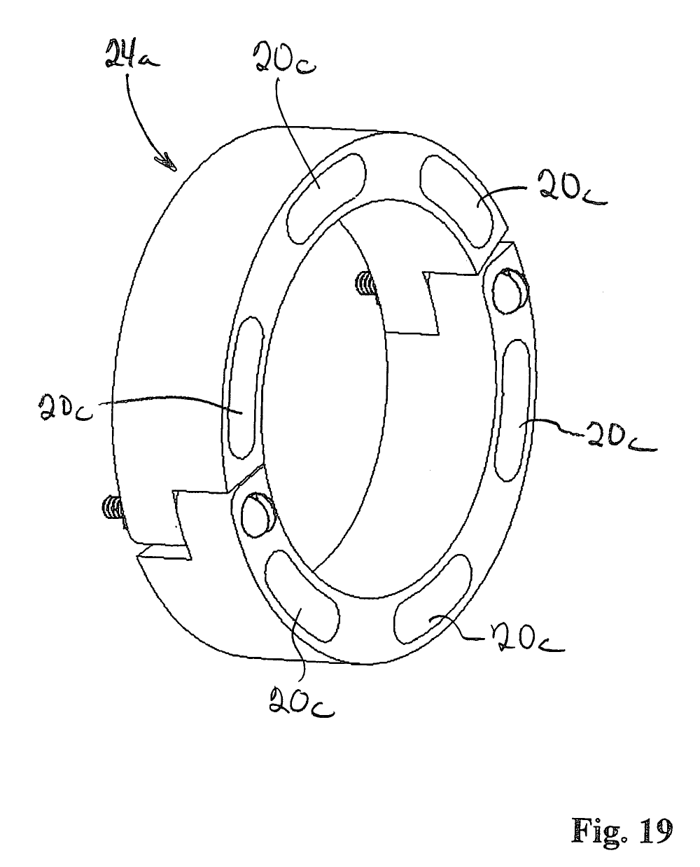

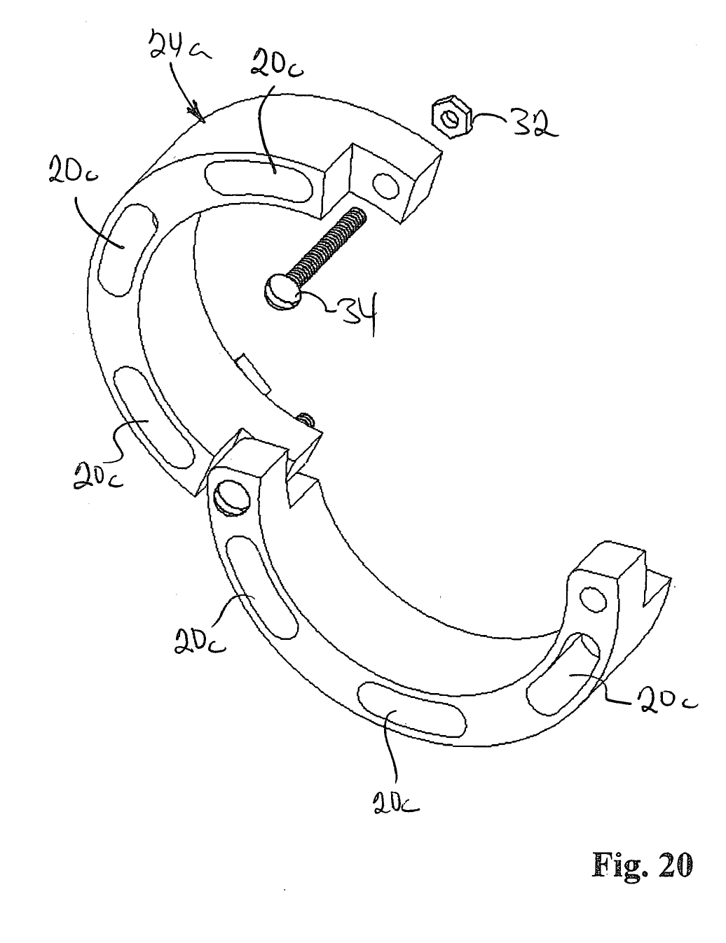

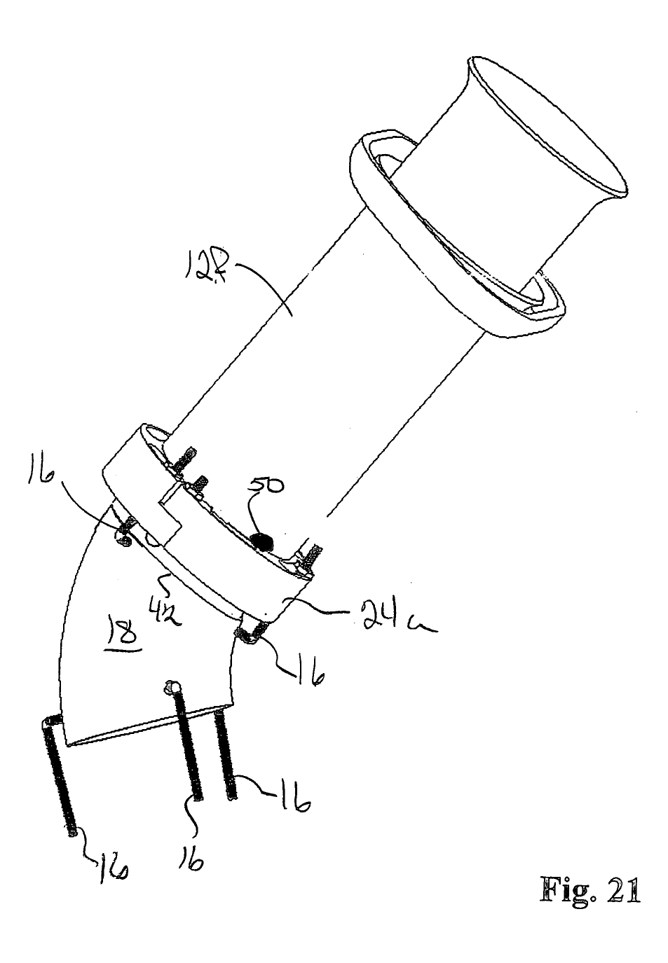

FIGS. 19 and 20 illustrate a split clamp collar 24a compatible with the present invention. This embodiment of a clamp collar 24a does not define interior grooves. The clamp collar 24a defines six elongated arcuate axial apertures 20c instead of the three such apertures defined by the clamp collar 24 of FIGS. 5-7. The clamp collar 24a is configured to be tack welded adjacent the free end of a selected straight tube portion as shown in FIG. 21. The tack welded clamp collar 24a provides a radially projecting anchor for receiving threaded studs 16 extending from a selected tube bend portion 18. The lack of relative movement between the clamp collar 24a and the straight tube portion 12f is in part remedied by the provision of additional arcuate axial apertures 20c permitting installation of the tube bend portion 18 in a plurality of rotational positions relative to the straight tube portion 12f. It can be seen that the butt joint 42 formed between the straight tube portion 12f and the tube bend portion 18 is accessible to permit tack welding. After the tube assembly is tack welded, the welds 50 securing the clamp collar 24a to the straight tube portion 12f are ground away and the clamp collar 24a is opened and removed before the joint 42 is finish welded and ground.

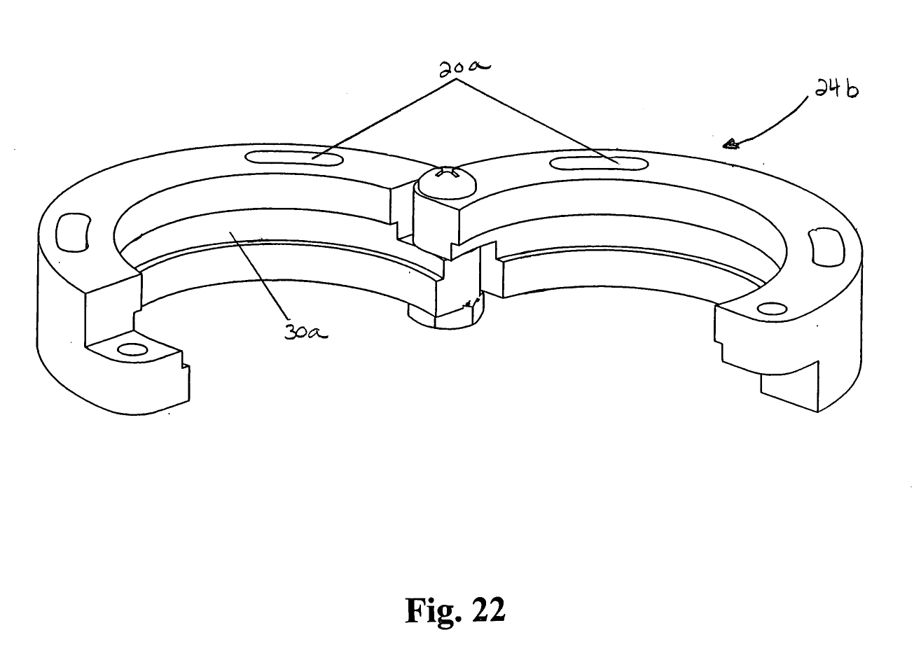

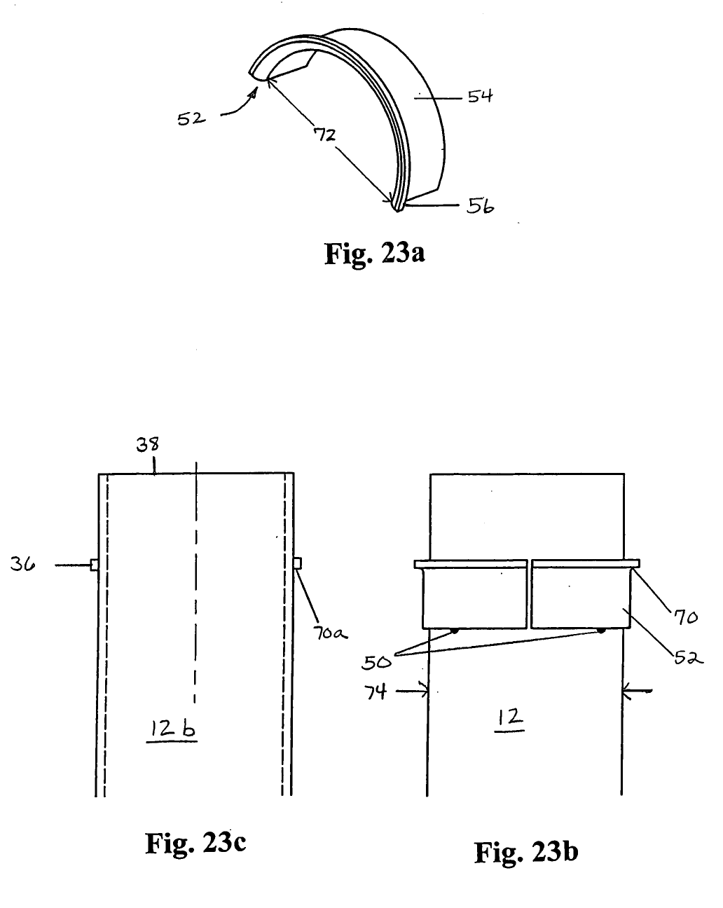

FIGS. 22-25 illustrate a further variation of the hardware employed to provide a radially projecting anchor compatible with the present invention. The radially projecting anchor of FIGS. 22-25 is a fixed shoulder and clamp assembly similar to the anchor of FIGS. 5-13. A fixed shoulder is provided by a plurality of flange portions 52 welded to the outside surface of a straight tube. Each flange portion includes an arcuate body 54 and a substantially perpendicular projection 56 as seen in FIG. 23a. The arcuate body 54 of the flange portions 52 has an inside diameter 72 substantially equal to the outside diameter 74 of the straight tube 12. The illustrated flange portions 52 are semi-cylindrical and are employed in pairs to provide a fixed radially projecting shoulder 70, although other flange portion configurations are compatible with the present invention. FIG. 22 illustrates an alternative embodiment of a split clamp collar 24b configured to close over the straight tube 12 and installed flange portions 52. The collar 24b has interior groove 30a that is continuous about the inside circumference. The groove 30a permits rotational movement of the collar 24b relative to the straight tube 12 to facilitate alignment of tube portions during mechanical assembly of the non-linear tube.

The groove 30a is defined between inward projecting lips 75 and 76. Lip 76 has diameter 53 to accommodate the thickness of the installed flange portions 52. Lip 75 has a smaller diameter 51 since it need only accommodate the straight tube 12. In a composite tube assembly, lip 76 abuts the radially projecting shoulder 70 provided by the flange portions 52 to prevent axial movement of the clamp collar 24b toward the end face 38 of the straight tube 12. The clamp collar 24b further defines a plurality of elongated arcuate apertures 20a which are arranged to receive the threaded studs 16 of a selected tube bend portion 18.

FIG. 23c is a partial sectional view through a straight tube 12b provided with weld studs 36. The weld studs 36 together form a fixed radially projecting shoulder 70a, which the clamp collar 24 of FIGS. 5-7 abuts during assembly. FIG. 23b illustrates an alternative fixed radially projecting shoulder 70 formed by flange portions 52 tack welded to straight tube portion 12. The flange portions 52 are secured by tack welds 50. The tack welds 50 may be formed using a MIG or TIG welder. The flange portions 52 are preferably a multi-part component to facilitate installation and removal from the non-linear tubular assemblies.

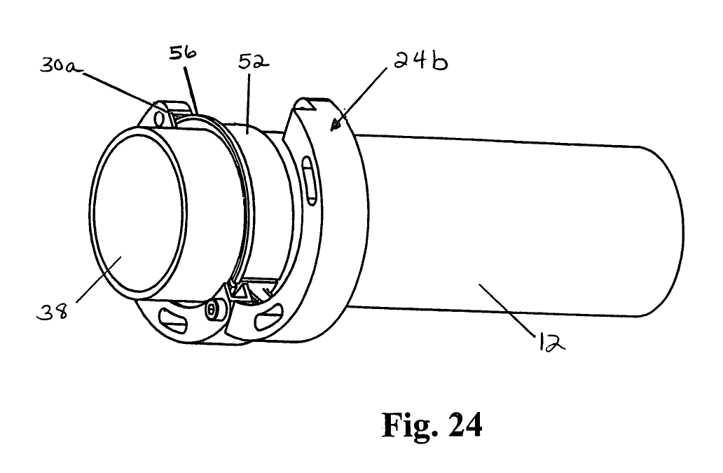

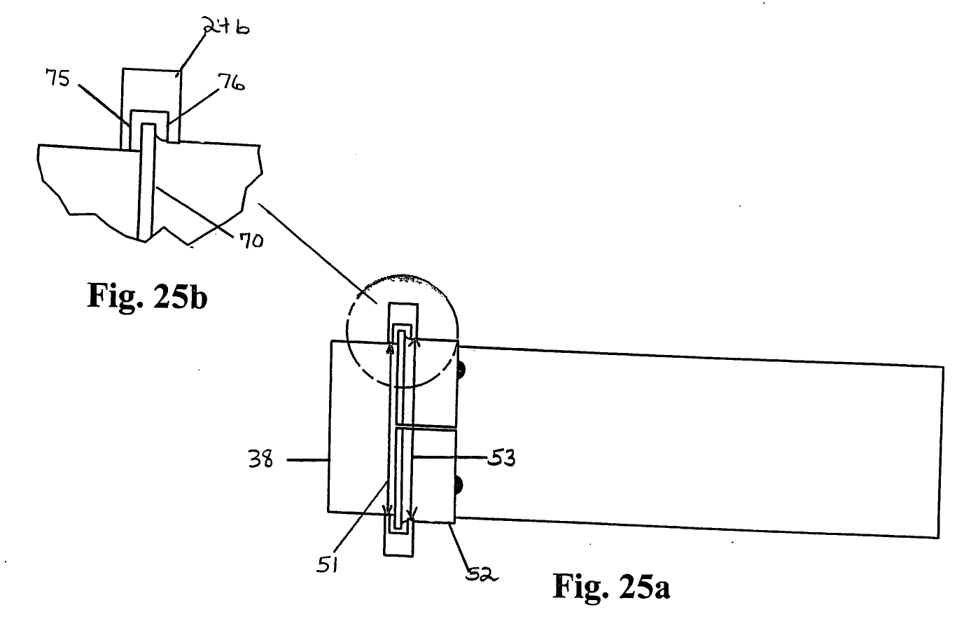

As shown in FIGS. 24 and 25a, the clamp collar 24b is closed around the flange portions 52 and straight tube 12 so that the radial projections 56 of the flange portions are received in the interior groove 30a. The interior groove 30a is configured to permit relative rotational movement between the clamp collar 24b and the straight tube 12. The radially extending shoulder 70 abuts the clamp collar 24b and does not permit the axial movement of the clamp collar 24b toward the end face 38 of the straight tube 12. When the clamp collar 24b is closed around the flange portions 52 and straight tube and secured (as shown in FIG. 25a), the assembly provides a radially projecting anchor on the straight tube 12. A selected tube bend portion 18 may then be assembled to the straight tube portion 12b in a manner analogous to FIGS. 10-11. It is an aspect of the invention that the clamp collar 24b may be used with either the weld studs 36 or with the flange supports 52. This is accomplished by changing the orientation of the split clamp collar 24b so that lip 75 with diameter 51 abuts the shoulder 70a formed by the several weld studs 36.

It is an aspect of the embodiment of the invention illustrated in FIGS. 22-25 to enable a fabricator to construct a tubular assembly without the use of stud welding equipment. According to this embodiment, the tubular components are assembled using a MIG or TIG welder and a metal cutting chop saw. Eliminating the need for stud welding equipment reduces the cost of making custom exhaust pipe systems and makes the process of non-linear exhaust system assembly more accessible to home auto mechanics.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed is:

1. A method for assembling first and second tubes having substantially the same constant diameter comprising:
selecting a first tube having a first axis and first and second ends, at least said second end having an end face substantially perpendicular to said first axis;
selecting a second tube having a second axis and first and second ends, at least said first end having an end face substantially perpendicular to said second axis;
fixing a first radially projecting anchor to an outside surface of said first tube adjacent the second end of said first tube with an axial portion of said first tube exposed between said first radially projecting anchor and the end face of said second end;
fixing a plurality of threaded pins to an outside surface of said second tube adjacent the first end of said second tube with an axial portion of said second tube exposed between said plurality of threaded pins and said end face, said threaded pins extending substantially parallel to said second axis and axially beyond said second end;
attaching said first tube second end to said second tube first end by:
passing said threaded pins through said radially projecting anchor; and
threadably engaging a nut with each of said threaded pins;
adjusting the relative lateral positions of said first and second tubes so that the end faces are radially and axially aligned;
adjusting the relative rotational positions of said first and second tubes to form a selected tubular configuration defined by said first and second axes; and
tightening said nuts to secure said first tube to said second tube with said end faces in contact to form a circumferential butt joint, said joint being accessible at a plurality of locations distributed about said joint, said threaded pins, anchor and nuts applying an axial compression force and rotational stability to said circumferential butt joint sufficient to maintain the alignment of said end faces and the selected tubular configuration.

2. The method of claim 1, wherein said step of fixing a first radially projecting anchor comprises:
attaching a radially projecting shoulder to an outside surface of said first tube, said shoulder being axially spaced from the end face of said second end.

3. The method of claim 1, wherein said step of fixing a first radially projecting anchor comprises:
providing at least one flange support, each said flange support having an arcuate axially extending portion and a radially projecting flange; and
welding said axially extending portion to said first tube outside surface with said flange axially spaced from the end face of said second end.

4. The method of claim 1, wherein said step of fixing a first radially projecting anchor comprises:
welding a flange to an outside surface of said first tube to provide a radially extending shoulder axially spaced from the end face of said second end; and
installing a collar about said first tube and said flange, said collar configured to receive said flange and permit rotational movement of said collar relative to said first tube while said flange abuts said collar to prevent axial movement of the collar toward the end face of said second end.

5. The method of claim 1, wherein said step of fixing a first radially projecting anchor comprises:
fixing a plurality of flange portions to the outside surface of said first tube at axially aligned locations about a circumference of said first tube, each said flange portion comprising an arcuate body and a substantially perpendicular projection, the projections of said plurality of flange portions defining a shoulder axially spaced from the end face of said second end; and
installing a collar about said first tube and said flange portions, said collar configured to permit rotational movement of said collar relative to said first tube while said shoulder and said collar abut to prevent axial movement of the collar toward the end face of said first tube second end.

6. The method of claim 5, wherein said collar comprises a plurality of parts connectable to form a ring and installing said collar comprises:
closing said collar around said tube and said flange portions and connecting the parts with hardware.

7. The method of claim 5, wherein said collar defines a plurality of apertures arranged to receive said threaded pins.

8. The method of claim 1, comprising:
tack welding said first tube second end to said second tube first end at a plurality of said accessible locations to fix said first and second tubes in the relative positions secured by said threaded pins, anchor and nuts;
loosening and removing said nuts;
removing said radially projecting anchor;
removing said plurality of threaded pins;
completing a weld around the circumferential butt joint; and
smoothing said weld.

9. A system for producing non-linear tubular assemblies from straight tube portions and tube bend portions of substantially the same substantially constant diameter comprising:
a plurality of tube bend portions defining a range of tube bend angles, each said tube bend portion having an outside surface extending between first and second ends and including a first plurality of threaded pins secured to said outside surface adjacent said first end and a second plurality of threaded pins secured to said outside surface adjacent said second end, each of the threaded pins in said first plurality configured to extend generally parallel to said outside surface and axially beyond the first end, and each of the threaded pins in said second plurality configured to extend generally parallel to said outside surface and axially beyond said second end;
a plurality of straight tube portions; and
an anchor securable to said straight tube portions, said anchor defining at least one aperture; and
a plurality of nuts complementary to said threaded pins,
wherein said non-linear tubular assemblies are produced by:
selecting a first tube from said plurality of straight tube portions having a first axis and a first free end to be joined, said first free end having a first end face;
selecting a second tube from said tube bend portions, said second tube having a second axis and a second free end to be joined, said second free end having a second end face;
fixing said anchor to said first tube adjacent said first free end;
attaching said first free end to said second free end by:
passing said threaded pins through said at least one aperture;
and threadably engaging a nut with each of said threaded pins;
adjusting the relative lateral positions of said first and second tubes so that said first and second end faces are radially and axially aligned;
adjusting the relative rotational positions of said first and second tubes to form a selected tubular configuration; and
tightening said nuts to secure said first tube to said second tube with said end faces in contact to form a circumferential butt joint, said joint being accessible at a plurality of locations distributed about said joint, said threaded pins, anchor and nuts applying an axial compression force and rotational stability to said circumferential butt joint sufficient to maintain the alignment of said end faces and the selected tubular configuration.

10. The system of claim 9, wherein said tube bend portions are provided in a range of tube bend angles between approximately 5° and approximately 140°.

11. The system of claim 9, wherein said tube bend portions are provided in approximately 2° increments over a range of between approximately 5° and approximately 140°.

12. The system of claim 9, wherein said anchor comprises:
a plurality of flange portions, each flange portion comprising an arcuate body and a substantially perpendicular projection, said flange portion bodies secured to said first tube whereby said projections are axially aligned and together define a radially projecting shoulder; and
a collar configured to surround said first tube and flange portions, said collar defining a groove which receives said shoulder to permit rotational movement of said collar relative to said first tube while said shoulder and said collar abut to prevent axial movement of the collar toward the end face of said first tube second end.

13. The system of claim 9, wherein said anchor comprises:
a discontinuous flange secured to an outside surface of said first tube and axially spaced from said first end face; and
a circumferential collar defining a groove configured to receive said flange and permit rotational movement of said collar relative to said first tube while said flange and said collar abut to prevent axial movement of the collar toward said first end face.

14. The system of claim 9, comprising:
tack welding said first free end to said second free end to fix said first and second tubes in the selected tubular configuration;
loosening and removing said nuts;
removing said radially projecting anchor;
removing said plurality of threaded pins; and
completing a weld around the circumferential butt joint.

15. An anchor for use in conjunction with a tubular component, said anchor comprising:
a shoulder welded to an outside surface of said tubular component axially spaced from an end face of said tubular component; and
a collar assembly comprising a plurality of arcuate portions, said arcuate portions configured to overlap each other and removably secured to each other said collar defining a plurality of axial apertures,
wherein said collar assembly is configured to surround said tubular component, said shoulder preventing axial movement of the collar toward said end face and said collar is free to rotate about the circumference of said tubular member.

16. The anchor of claim 15, wherein said shoulder comprises:
a plurality of flange portions, each said flange portion including an arcuate body and a substantially perpendicular projection, said flange portions welded to said outside surface with said projections at substantially the same axial distance from said end face, the projections of said plurality of flange portions together forming said shoulder.

17. The anchor of claim 15, wherein said shoulder comprises:
a plurality of studs welded to said outside surface at substantially the same axial distance from said end face, each said stud projecting radially from said outside surface, said studs together providing said shoulder.

18. The anchor of claim 15, wherein said collar assembly comprises two semi-circular portions secured to each other by a fastener axially extending through the overlapped ends of said semi-circular portions.

19. The anchor of claim 15, wherein said collar assembly defines an inward facing circumferential channel configured to receive said shoulder.
